(19) United States
(12) Patent Application Publication
(10) Pub. No.: US 2014/0202957 A1
(43) Pub. Date: Jul. 24, 2014

(54) METHOD FOR IMPROVING THE PERCENT RECOVERY AND WATER QUALITY IN HIGH TOTAL HARDNESS WATER

(71) Applicant: Fan-Sheng Teddy Tao, Missouri City, TX (US)

(72) Inventor: Fan-Sheng Teddy Tao, Missouri City, TX (US)

(73) Assignee: Chevron U.S.A. Inc., San Ramon, CA (US)

(21) Appl. No.: 13/836,317

(22) Filed: Mar. 15, 2013

Related U.S. Application Data
(60) Provisional application No. 61/754,399, filed on Jan. 18, 2013.

(51) Int. Cl. C02F 9/00; C02F 5/08; C02F 5/06; C02F 1/44; C02F 1/42

(52) U.S. Cl. CPC C02F 9/00; C02F 1/441; C02F 1/42; C02F 5/06; C02F 5/08
USPC 210/638

(57) ABSTRACT

A method is disclosed for improving the percent recovery and water quality in water with high levels of hardness. Embodiments of the method include receiving a produced water composition, partially softening the water composition, and directing the partially softened water composition through at least one reverse osmosis unit. The method may be used to purify and clarify produced water from oil and gas operations for use in boilers or once-through steam generators.

### CROSS-REFERENCE TO RELATED APPLICATION

The present application claims the benefit of U.S. Provisional Patent Application No. 61/754,399, filed on Jan. 18, 2013, incorporated herein by reference.

### TECHNICAL FIELD

The present disclosure generally relates to methods for purifying and clarifying water. Specifically, an embodiment of the method is directed to purifying water with high total hardness levels produced from oil and gas operations to result in cleaner, boiler or drinking quality water.

### BACKGROUND

Fluid recovered from an oil and gas production well (production or produced fluid) comprises a mixture of hydrocarbons and water. The mixture is generally separated into gas, oil and water phases, and these individual phases are further processed or purified. In order to reduce operating costs, water recovered from production wells can be recycled into well operations. In one case, the recovered water can be used in steam flooding operations. However, steam flooding requires removing the hardness from water down to less than 1.0 ppm. Depending on the reservoir, the hardness of recovered water can range from around 20 to over 10,000 ppm.

Conventional methods of water softening include reducing hardness using alkaline materials to raise pH, thereby causing precipitation of the hard materials. However, this method is expensive because it uses a large amount of alkaline chemicals and leaves a large amount of precipitates to dispose of Another method uses ion-exchange resins, such as strong acid cation (SAC) exchange resins, to soften water. These ion-exchange resins can also be costly to buy and run, and many units may be needed. While these methods work at lower levels of hardness, these methods are not economical at higher levels of hardness because they use a significant amount of salt for regeneration. Further, it is difficult to soften the higher ranges of hardness found in recovered water by using these conventional water softeners, especially when the total dissolved solids (TDS) exceed 5,000 ppm level. In the case of high TDS, a weak acid softener (WAC) is usually used. WAC softeners use acid for regeneration, which can also become expensive at higher levels of hardness due to the use and disposal of acids.

For instance, a high pressure boiler requires a feed water with total dissolved solids (TDS) below 20 ppm and close to zero levels of hardness (calcium, magnesium, strontium and barium, for example). Conventionally, a two pass RO membrane system is required to achieve such a low TDS and hardness level for the boilers. For example, produced water with approximately 8000 ppm of TDS and 4000 ppm of hardness could reach a TDS below 20 ppm with a two-pass RO membrane system. However, the percent recovery for producing the permeate water with this system would only reach about 55%. The other 45% would be concentrate water that is unusable in a boiler system.

### SUMMARY

Embodiments of the disclosure include methods to reduce the hardness and TDS in produced water. One embodiment of the disclosure is a method of improving the percent recovery in water with high levels of hardness, the method comprising: a) receiving a produced water composition, b) partially softening the water composition, c) adding an antiscalant to the partially softened water composition, and c) directing the partially softened water composition through at least one reverse osmosis unit. In embodiments of the disclosure, the effluent is directed from the reverse osmosis unit to a boiler or a once-through steam generator. The produced water may be pretreated prior to being partially softened. For example, pretreatment may include filtering large particles out of the produced water, and removing gas and oil. The method may additionally include a decarbonator unit. The partially softened water may be cooled prior to directing the partially softened water composition through at least one reverse osmosis unit or heated prior to partial water softening. In some embodiments, the water is cooled to less than 100° C., less than 95° C., less than 93° C., less than 90° C., or less than 80° C.

In embodiments of the disclosure only one RO unit is used. In other embodiments of the disclosure, more than one RO unit is used. In a specific embodiment of the disclosure, two RO units are used. In some embodiments, the concentrate (reject) stream from the second RO unit may be recycled back into the influx of the first RO unit. The RO membrane may be a reverse osmosis membrane (RO), or a nanofiltration (NF) membrane. In embodiments of the disclosure, the RO membrane is a high recovery RO membrane. In some embodiments, the RO membrane is a high temperature membrane. The high temperature membrane unit could be a reverse osmosis (RO) membrane unit, or a nanofiltation (NF) membrane unit. For example, the high temperature reverse osmosis unit can have a maximum temperature of between 120 to 210° F.

In embodiments of the disclosure, partially softening the water comprises using a chemical softener or an ion exchange resin based water softener. In embodiments, the chemical softener is lime, soda ash, or a combination thereof. In other embodiments of the disclosure, the water softener is a strong acid cation softener or a weak acid cation softener. In some embodiments of the disclosure, partially softening the water comprises reducing the hardness of the produced water composition by about 30-70%, about 40-80%, about 50-70%, or about 50-60%. In some embodiments of the disclosure, partially softening the water composition comprises reducing the hardness of the produced water to at most about 10, about 25, about 50, about 100, about 200, about 300, about 400, about 500, about 750, about 1000, about 1500, about 2000, about 2500, about 3000, about 4000 or about 5000 ppm. In specific embodiments, the produced water composition comprises a TDS of greater than greater than 3000, greater than 4000, greater than 5000, greater than 6000, or greater than 7000.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow diagram of an embodiment of the invention; and

FIG. 2 is an example of a system of the disclosure.

### DETAILED DESCRIPTION

Aspects of the present invention describe a method for purifying water with high levels of hardness. An embodiment of the disclosure is a method of using RO membranes with partially softened water to reduce the total hardness and total dissolved solids (TDS) of the water, and to produce a high quality water for various purposes.

As used herein, the term “equal” refers to equal values or values within the standard of error of measuring such values. The term “substantially equal,” or “about” as used herein, refers to an amount that is within 3% of the value recited.

As used herein, “a” or “an” means “at least one” or “one or more” unless otherwise indicated.

“Hardness” as used herein, refers to the concentration of multivalent cations, represented in parts per million (ppm). Typically the multivalent cations are calcium, magnesium, strontium and barium. The total hardness is a summation of calcium, magnesium, strontium, and barium ions in terms of calcium carbonate equivalent values. “High hardness,” as referred to herein, refers to water with a hardness of over 1000 ppm, over 2000 ppm, over 3000 ppm, over 4000 ppm, over 5000 ppm, over 6000 ppm, over 7000 ppm, over 8000 ppm, over 9000 ppm, over 10,000 ppm, over 11,000 ppm, or over 12,000 ppm calcium carbonate equivalent.

“Water softening,” as used herein, refers to removing hardness from the water. “Partial water softening,” as used herein, refers to removing at most 30%, at most 40%, at most 50%, at most 60%, or at most 70% of the hardness from the water. Partial water softening can result in a water that has at least about 10, about 25, about 50, about 75, about 100, about 200, about 300, about 400, about 500 ppm, about 1000, ppm, about 1500 ppm, about 2000 ppm, about 2500 ppm, about 3000 ppm, about 4000 ppm, about 5000 ppm, about 6000 ppm, or about 7000 ppm hardness.

As used herein “boiler quality water” refers to water with TDS less than 20 and hardness levels less than 0.5 ppm, or equal to 0 ppm. “Once-through steam generator quality water” refers to water with hardness levels less than 0.5 ppm.

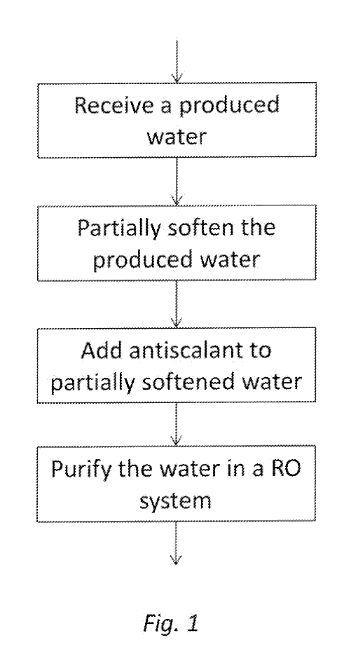

FIG. 1 illustrates an embodiment of the disclosure. First produced water is received. The produced water may have been previously pretreated to remove gas, oil, and larger particles. The produced water is then partially softened. After which antiscalant is added to the partially softened water, and the partially softened water is then run through a reverse osmosis system. The reverse osmosis system may include one or more reverse osmosis units. In an embodiment of the invention, two RO units are used. In the case of using more than one RO units, the reject water from the second RO units may be recycled back into the influx of the first RO unit. In another embodiment, the RO unit includes reverse osmosis/nanofiltrate (RO/NF) membranes.

An embodiment of the disclosure is purifying high hardness water down to boiler quality water. For example, produced water from one type of reservoir consists of approximately 3,800 ppm of total hardness, while steamflooding requires a hardness of less than 1.0 ppm. Embodiments of the disclosure use partial water softening followed by one or more RO membranes. The RO membranes may be high recovery RO membranes.

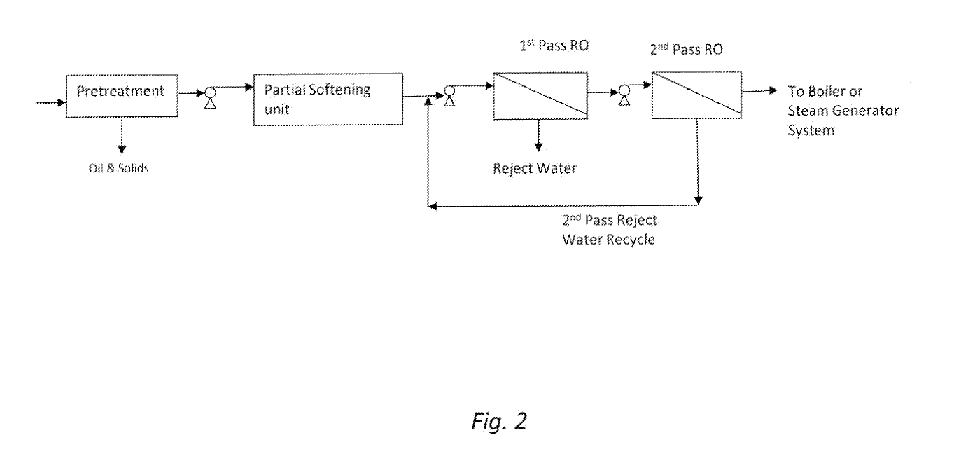

FIG. 2 illustrates an embodiment of the disclosure. Prior to softening the water, oil, gas and solids may be removed from the production fluids in pretreatment. This process can include a holding tank followed by flotation units and filters. It is anticipated that a flotation unit can remove up to about 95% of oil and some of the gases, such as hydrogen sulfide and carbon dioxide, from water. An ultra-filtration unit, such as a ceramic UF membrane unit may also be used prior to the softening and RO system of the current disclosure. The water may also be heated or cooled prior to entering the softening system (chemical or softener based), or after going through the softening system and before entering the RO system. For example, the water may be cooled to lower than 113° F. (45° C.) prior to going through the RO system but after going through the softening system. As another example, the water may be heated prior to chemical softening methods. After pretreatment, the produced water is then partially softened in a partial softening unit. The unit may use chemical softening, or an ion-exchange resin based softening unit.

In embodiments of the disclosure, partial softening is achieved through the use of an ion exchange water softener. Softeners include ion-exchange resins in which multivalent ions are exchanged for ions located on the resins, such as Na⁺. Water softeners include weak acid cation (WAC) and strong acid cation (SAC) softeners, either of which may be used in embodiments of this disclosure. In an embodiment of the disclosure, no WAC softeners are used and approximately half the number of SAC softener units are used than what would be used for full softening of the water.

In embodiments of the disclosure, partial softening is achieved through the use of chemicals. For example, partial softening could be achieved by the addition of sodium carbonate, sodium bi-carbonate, lime, magnesium salts, caustic, or combination of these salts. One example of a commercial chemical softening process is a hot or warm lime softening process. In the case of chemical softening, the chemicals cause a partial precipitation of the hardness materials from the water, which may then be followed by thickener unit and/or a clarification unit prior to entering the RO membrane. Thickening units are used for promoting precipitation of the solids. For handling the oily produced water, thickening units promote the separation of oil from water. These units may have an arm to promote thickening of the solids, while others use recirculation of solids to provide seeding to the incoming chemically treated fluids. A coagulation chemical may be added to promote the precipitations. A clarifier unit takes the upper layer of water (after solid separation) to be further clarified. Some clarifier units may be equipped with incline baffles near the top of the tank to coagulate and settle the residual solids.

An antiscalant may be added to the water prior to going through the RO system to prevent fouling of the RO filter. Examples of antiscalants include HCl, sulfuric acid, or other types of acids, and/or conventional scale inhibitors. Additionally, a decarbonator unit may be added prior to water softening, after water softening but prior to the RO system, or after the RO system.

The RO unit comprises an RO membrane, such as a RO/NF membrane. The RO membrane may also be a high recovery RO membrane and/or a high temperature RO membrane. In some cases, more than one RO unit may be linked to other RO units, either in parallel, in series, or using a combination thereof. The recovery percentage of the water may also be increased by recycling the concentrate (reject) water from RO units later in the line back into the influx lines of previous RO units.

Further, in a high temperature environment, such as steam flood, a high temperature RO/NF (reverse osmosis or nanofiltration) membrane system is used to conserve energy, reduce hardness and TDS. The energy savings is significant in comparison with the use of traditional RO/NF membranes whereas the maximum tolerance temperature is 113 F, while high temperature membranes can have a tolerance temperature of 120-210 F, for example. In some embodiments, a cooling system would not be need when using a high temperature membrane system. In some embodiments, the high RO membranes have recovery of up to 75% using partial softening to protect the fouling and scaling in the membrane elements. In some embodiments, with the high recovery and reduction of TDS and hardness, the high temperature membranes permeate water can reach boiler quality water level of <20 ppm TDS.

After running through the partial water softening system followed by the RO system, the water may then be supplied as feed water to a boiler or once-through steam generator (OTSG). For example, an OTSG could provide up to 75-80% quality steam, and a boiler could provide 97% or better quality steam for a more effective steam flood, given water that was processed through partial softening and RO.

The methods of the disclosure may be performed either on-shore or off-shore, and may be adjusted to make the most efficient use of the location. As an example, ion exchange water softening systems may be used off-shore in order to reduce the amount of chemicals and waste solids that need to be transported to and from the rig.

### EXAMPLES

The following examples are included to demonstrate specific embodiments of the disclosure. It should be appreciated by those of skill in the art that the techniques disclosed in the examples that follow represent techniques discovered by the inventors to function well in the practice of the invention, and thus, can be considered to constitute modes for its practice. However, those of skill in the art should, in light of the present disclosure, appreciate that many changes can be made in the specific embodiments disclosed and still obtain a like or similar result without departing from the spirit and scope of the invention.

### Example 1

### Simulation of Partial Water Softening

A simulation of partial water softening was run using programs specifically designed by membrane companies for the specific membrane used.

Parameters:
1. Water Analysis: Simulated produced water was used for the software programs for membrane calculations.
2. Boiler Water Requirement: 207,000 BWPD for the treated produced water to meet the boiler water specifications. For the produced water, this would require approximately 300,000 BWPD for the RO membrane system, if the recovery factor is about 69-70%.
3. Water Temperature: A temperature not exceeding 45° C. (113° F.) was used for this study. 113° F. is the maximum tolerance temperature for the RO membranes used in this example.

The results showed that with a two-pass RO membrane process, with recycling of the 2^{nd} pass concentrate (reject) stream, recovery was 73% (Table 2). The quality of water was reached TDS of 4.85 ppm with only 0.01 ppm of calcium (no magnesium, strontium, barium), this calcium would be equivalent to 0.025 ppm of total hardness (Table 2).

Table 1 below contains the results of the first pass in a high-recovery low pressure RO membrane process simulation with RO recycling.

TABLE 1
Pass Streams
(mg/l as Ion)

| | | Adjusted Feed | | | | |
|---|---|---|---|---|---|---|
| | | | After | Concentrate | Permeate | |
| Name | Feed | Initial | Recycles | Stage 1 | Stage 1 | Total |
| NH4+ + | 0.00 | 0.00 | 0.00 | 0.00 | 0.00 | 0.00 |
| NH3 | | | | | | |
| K | 89.45 | 89.45 | 74.84 | 336.08 | 1.21 | 1.21 |
| Na | 1137.71 | 1137.71 | 950.71 | 4274.70 | 13.82 | 13.82 |
| Mg | 213.61 | 213.61 | 177.01 | 802.75 | 0.64 | 0.64 |
| Ca | 925.09 | 925.09 | 766.51 | 3476.50 | 2.69 | 2.69 |
| Sr | 35.12 | 35.12 | 29.10 | 131.98 | 0.10 | 0.10 |
| Ba | 0.00 | 0.00 | 0.00 | 0.00 | 0.00 | 0.00 |
| CO3 | 8.54 | 8.54 | 5.39 | 144.89 | 0.00 | 0.00 |
| HCO3 | 1072.63 | 1072.63 | 900.58 | 3801.04 | 14.30 | 14.30 |
| NO3 | 0.00 | 0.00 | 0.00 | 0.00 | 0.00 | 0.00 |
| Cl | 2491.55 | 2556.10 | 2127.39 | 9604.91 | 19.81 | 19.81 |
| F | 0.00 | 0.00 | 0.00 | 0.00 | 0.00 | 0.00 |
| SO4 | 1264.32 | 1264.32 | 1045.90 | 4751.45 | 1.47 | 1.47 |
| SiO2 | 16.47 | 16.47 | 13.86 | 61.87 | 0.32 | 0.32 |
| Boron | 2.23 | 2.23 | 2.42 | 6.93 | 1.15 | 1.15 |
| CO2 | 39.87 | 39.87 | 40.28 | 98.42 | 48.62 | 48.62 |
| TDS | 7267.23 | 7331.77 | 6105.13 | 27425.75 | 60.95 | 60.95 |
| pH | 7.28 | 7.28 | 7.22 | 7.25 | 5.59 | 5.59 |

Table 2 below contains the results of the second pass in a high-recovery low pressure RO membrane process simulation with RO recycling.

TABLE 2
Pass Streams
(mg/l as Ion)

| | | | Concentrate | Permeate | |
|---|---|---|---|---|---|
| Name | Feed | Adjusted Feed | Stage 1 | Stage 1 | Total |
| NH4+ + NH3 | 0.00 | 0.00 | 0.00 | 0.00 | 0.00 |
| K | 1.21 | 1.21 | 5.34 | 0.02 | 0.02 |
| Na | 13.82 | 13.82 | 60.79 | 0.17 | 0.17 |
| Mg | 0.64 | 0.64 | 2.82 | 0.00 | 0.00 |
| Ca | 2.69 | 2.69 | 11.90 | 0.01 | 0.01 |
| Sr | 0.10 | 0.10 | 0.45 | 0.00 | 0.00 |
| Ba | 0.00 | 0.00 | 0.00 | 0.00 | 0.00 |
| CO3 | 0.00 | 0.00 | 0.01 | 0.00 | 0.00 |
| HCO3 | 14.30 | 14.30 | 62.53 | 1.45 | 1.45 |
| NO3 | 0.00 | 0.00 | 0.00 | 0.00 | 0.00 |
| Cl | 19.81 | 19.81 | 87.30 | 0.19 | 0.19 |
| F | 0.00 | 0.00 | 0.00 | 0.00 | 0.00 |
| SO4 | 1.47 | 1.47 | 6.53 | 0.00 | 0.00 |
| SiO2 | 0.32 | 0.32 | 1.41 | 0.01 | 0.01 |
| Boron | 1.15 | 1.15 | 3.30 | 0.52 | 0.52 |
| CO2 | 48.62 | 48.62 | 48.71 | 47.75 | 47.74 |
| TDS | 60.95 | 60.95 | 257.98 | 4.85 | 4.85 |
| pH | 5.59 | 5.59 | 6.19 | 4.65 | 4.65 |

### Example 2

### Chemical Softening Testing

Based on a field application, results show that with the chemical softening method the use of a thickener-clarifier operation with a sophisticated UF filtration system, such as ceramic membranes for removing oil and solids in feed water of RO membrane application, may not be needed. Laboratory bottle and pilot tests were done to demonstrate the use of caustic, soda ash, or their combination, for partial softening of a produced water. In this case, the turbidity of water could be reduced to 0.2 Nephelometric Turbidity Units (NTU), which is suitable for the RO membrane operation. Testing used a synthetic water with 3800 ppm of hardness and about 8000 ppm of TDS.

The test procedure and results of each step are summarized as follows:

1. With 100 ml of the synthetic water, 5 drops of crude oil was added;

2. The sample was shaken 300 times in a prescription bottle;

3. Measured turbidity was 5 NTU

4. Temperature was 93° C. in a water bath for 1 hour;

5. Added 2200 ppm of sodium carbonate and mixed, the turbidity was 8 NTU;

6. Total hardness was reduced from 3360 ppm to 1613 ppm with 52% reduction.

7. After settling for 2 hours, the turbidity reduced from 8 to 0.21 NTU.

The results are summarized as follows:
1. In this case, an evaporation test shows that in order to have 75% water recovery without scaling about 50% original hardness should be removed.
2. Scale inhibitors are effective. Without the chemical scale tends to develop rapidly.
3. Caustic and soda ash can reduce half of the original hardness. A lower amount of caustic than soda ash can reduce the same amount of hardness, and produces a less amount of precipitates respectively.
4. For water containing oil particles, after treatment by either caustic or soda ash, the water quality is much better than controls (no soda ash or caustic). Further, soda ash treated water is better than caustic treated water; however, precipitates from adding soda ash tend to be more dense and stick to the bottom of prescribed glass bottles.
5. Higher temperature seems to help with clarifying oily water. As now with a temperature of 93 Celsius and a settling time of 3.5 hrs. The water turbidity treated by soda ash is 0.55 (initially 8).
6. Extensive settling might not be necessary at 93 Celsius. With initial turbidity 5.0, after two hours the turbidity is 0.21.

The above testing results show that the use of soda ash could reach a turbidity level of 0.2 NTU in 2 hours settling in a clarifier. This 0.2 NTU turbidity was established in testing for the treated water to be suitable for RO membrane operation.

The above testing results also show that partial softening is effective to reduce the total hardness to approximately 50% for a sample of produced water using scale inhibitors. Since the partial softening RO system increases the concentration of ions in the reject (concentrate) water, the concentration of hardness materials increases with the concentration increase. That is, when running a RO/NF membrane system at 50% recovery, the concentration of the ions will increase roughly by 50%. Hence, a way of handling this increase is decreasing the hardness by 50% prior to RO purification. When the hardness concentration decreases by 50%, then within the RO/NF system the ion concentration will increase about 50% when the system is run at 50% recovery. This technique effectively cancels the concentration effect of the increased hardness levels. It means that the concentration of hardness will keep the same as the feed water (before partial softening by 50%) throughout the RO/NF membrane system. Hence, this method minimizes the chemical treatment needed for scale control.

Additionally, the total softening process could also provide steam for the OTSG steam generator operations. The partial softening with RO membranes would also be able to supply feed water for boilers. The OTSG would provide up to 75-80% quality steam, and boiler would provide 97% or better quality steam for more effective steam flood.

### Example 3

### Partial Water Softening with a High Temperature Membrane

A GE high temperature reverse osmosis membrane was used in this example. The membrane used was a high temperature reverse osmosis membrane that can operate at up to 70° C. Using GE's Winflows software, simulations were conducted for both two pass and three pass system layouts. Determination of the maximum overall recovery and the lowest TDS was conducted based on a trial-and-error manner. Any configuration that yields system error (except scale-indicating errors, scale prevention will be addressed by partial softening) was excluded from further consideration. Feed composition was modified to reflect 50% hardness removal for partial softening. In addition to eliminating systematic errors, caution was taken for limiting the maximum cross sectional flow rate to be lower than 20 GFD as suggested by the manufacturer.

For the handling 300,000 B/D (or 8750 gpm) of produced water using a two pass design with a total number of 5080 elements in total. The line from the second pass reject stream was recycled back into the first RO input stream. The three pass design had a total number of 6688 elements. The concentrate from the second pass was recycled back to the feed stream. The concentrate from the third pass combined with the concentrate from the first pass to form the total concentrate.

As shown in the table below, the two pass design recovered 4.2% more water than the three pass design does, however, the TDS was compromised by 15.62 mg/L. Temperature was set to 137 F which was the projected feed temperature achieved by using fin-fan cooler.

TABLE 3

| | | Permeate | | |
|---|---|---|---|---|
| | | TDS (mg/L) | | |
| | | at max | Overall | |
| Temp (° F.) | Temp (° C.) | recovery | recovery (%) | Configuration |
| 137 | 58.3 | 19.68 | 67.2 | Two pass |
| 137 | 58.3 | 4.07 | 63 | Three pass |

### REFERENCES

All patents and publications mentioned in the specification are indicative of the levels of skill in the art to which the invention pertains. All patents and publication are herein incorporated by reference to the same extent as if each individual publication was specifically and individually indicated to be incorporated by reference.
U.S. Pat. No. 5,250,185.
U.S. Patent Application 2012/0255904
U.S. Pat. No. 5,683,587

What is claimed is:

1. A method of improving the percent recovery in water with high levels of hardness, the method comprising:
a) receiving a produced water composition;
b) partially softening the water composition;
c) adding an antiscalant to the partially softened water composition; and
c) directing the partially softened water composition through at least one reverse osmosis unit.

2. The method of claim 1, further comprising directing the effluent from the reverse osmosis unit to a boiler or a once-through steam generator.

3. The method of claim 1, wherein the water composition has been previously processed to remove oil and gas.

4. The method of claim 1, further comprising using a decarbonator unit.

5. The method of claim 1, wherein the partially softened water composition is directed through two reverse osmosis units.

6. The method of claim 5, wherein the reject stream from the second reverse osmosis unit is recycled back to into the first osmosis unit.

7. The method of claim 1, wherein partially softening the water comprises using a chemical softener.

8. The method of claim 7, wherein the chemical softener is lime, soda ash, or a combination thereof.

9. The method of claim 1, wherein partially softening the water comprises using an ion exchange resin based water softener.

10. The method of claim 9, wherein the water softener is a strong acid cation softener.

11. The method of claim 9, wherein the water softener is a weak acid cation softener.

12. The method of claim 1, wherein partially softening the water comprises reducing the hardness of the produced water composition by about 30-70%, about 40-80%, about 50-70%, or about 50-60%.

13. The method of claim 1, wherein partially softening the water composition comprises reducing the hardness of the produced water to at most about 10, about 25, about 50, about 100, about 200, about 300, about 400, about 500, about 750, about 1000, about 1500, about 2000, about 2500, about 3000, about 4000 or about 5000 ppm.

14. The method of claim 1, wherein the produced water composition comprises a TDS of greater than greater than 3000, greater than 4000, greater than 5000, greater than 6000, or greater than 7000.

15. The method of claim 1, wherein the partially softened water is cooled prior to directing the partially softened water composition through at least one reverse osmosis unit.

16. The method of claim 15, wherein the water is cooled to less than 100° C., less than 95° C., less than 93° C., less than 90° C., or less than 80° C.

17. The method of claim 7, wherein the produced water is heated prior to partially softening the water composition.

18. The method of claim 1, wherein the reverse osmosis unit is a high temperature reverse osmosis unit.

19. The method of claim 18, wherein the reverse osmosis unit has a maximum temperature of between 120 to 210° F.
